(19) United States
(12) Patent Application Publication
(10) Pub. No.: US 2012/0029878 A1
(43) Pub. Date: Feb. 2, 2012

(54) Data Processing Device

(76) Inventors: Michael D. Carpenter, Arlington, TX (US); Matthias Krause, Orsingen-Nenzingen (DE); Svetlozar Delianski, Berlin (DE)

(21) Appl. No.: 13/192,732

(22) Filed: Jul. 28, 2011

Related U.S. Application Data
(60) Provisional application No. 61/369,192, filed on Jul. 30, 2010.

(30) Foreign Application Priority Data
Jul. 30, 2010 (DE) 10 2010 032 950.9

(51) Int. Cl. G06F 15/00

(52) U.S. Cl. 702/188

(57) ABSTRACT

A data processing device for use with a decentralized transport unit checking device is provided. The data processing devices includes a central data processing unit, remote from the transport unit checking device, and a first interface, which creates a data communication between the central data processing unit and the decentralized transport unit checking device. The central data processing unit processes a data record captured by the decentralized transport unit checking device in respect of a transport procedure of the transport unit. At least one second interface makes available the data record processed by the central data processing unit for calling up by a decentralized organization, wherein the organization initiates a security measure depending on data record.

### CROSS REFERENCE TO RELATED APPLICATIONS

The application claims the benefit of U.S. provisional patent application No. 61/369,192 filed Jul. 30, 2010, and claims priority of German patent application no. 10 2010 032 950.9 DE filed Jul. 30, 2010. All of the applications are incorporated by reference herein in their entirety.

### FIELD OF INVENTION

The claimed invention relates to a data processing device for use with a decentralized transport unit checking device, which is provided for the local checking of a transport unit.

### BACKGROUND OF INVENTION

The transport of goods is growing steadily given the current development of the global economy. Transport over long-haul, in particular intercontinental routes is particularly affected by this increase. With this trend the importance of the checking of transport containers in relation to the security-related aspects of these transport processes is likewise growing. The requirement hereby arises, particularly for official authorities in a destination country, for a rapid and flexible checking of transport containers, which are provided for import into the destination country.

### SUMMARY OF INVENTION

An object of the claimed invention is to provide a device in conjunction with the checking of transport units.

A data processing device for use with a decentralized transport unit checking device is proposed, which is provided for the local checking of a transport unit, comprising a central data processing unit remote from the transport unit checking device, a first interface, which creates a data communication between the central data processing unit and the decentralized transport unit checking device, where the central data processing unit processes a data record captured by the decentralized transport unit checking device in at least one operating mode in respect of a transport procedure of the transport unit, and at least one second interface, which makes the data record processed by the central data processing unit available for calling-up by a decentralized organization, which serves to initiate a security measure depending on the data record.

With the aid of a first interface a rapid, in particular direct remote access to a data record captured by the decentralized transport unit checking device can advantageously be achieved. By means of the second interface, the data record processed by the data processing unit can be called up by the organization in a particularly flexible manner, in particular independently of the location of the decentralized transport unit checking and the central data processing unit.

With the data processing device, data relating to a check performed on the transport unit prior to the arrival can be collected before the arrival of the transport unit at a destination or prior to on-site checking by the organization. The organization can hereby initiate a security measure relating to this transport unit before the actual arrival of the transport unit, if for example the organization becomes aware of suspicious events in connection with the transport of the transport unit or of an inadequate investigation of the transport at the starting location and/or an intermediate station unit. With the detection of problems in connection with a transport unit, a security level can be assigned to the transport unit, for which predefined security measures are to be initiated. With the aid of the central check data processing device the organization can accordingly perform a classification of transport units according to their respectively assigned security level.

The first interface can be provided to create a data communication with a multiplicity of decentralized transport unit checking devices, which are in particular arranged at different locations remote from each other. The second interface can additionally be provided in order to make the data record available for calling-up by a multiplicity of different organizations which are remote from each other. The central check data processing device is in particular suitable for use as a service, which can be made use of by different interested parties on a decentralized basis. The organization advantageously corresponds to an official authority, for example a customs authority, an internal security authority, a border control body, a coastguard, etc., which has at its disposal suitable means for performing a security measure.

The data processing device can in addition to the central data processing unit have a user interface, which can be operated on a decentralized basis by personnel of the organization for calling up data records from the central data processing unit.

In this connection the term “data processing” should be taken to mean in particular the forwarding, processing, conversion, encryption, storage, archiving, assignment, collation, provision, analysis, etc. of data. The term “checking” in connection with a transport unit should in particular be taken to mean the monitoring and/or the investigation of the transport unit. Checking can for example mean an investigation of the contents, monitoring of the transport unit and/or its environment, an inspection of the state of a seal, etc. The term. “transport unit” should in particular be understood as a unit specially equipped for the transport of goods.

The claimed invention is particularly suitable for the checking of transport containers, for example of standardized transport containers, which are specially designed for road, air, rail and/or maritime transport. The transport unit can further be embodied as a pallet or package. The term “provided” should in particular be taken to mean specially designed, equipped, embodied and/or programmed.

The decentralized transport unit checking device is provided for “local” checking, in that it preferably has at least one checking means, which is arranged in the vicinity, preferably in the immediate vicinity, of the transport unit, such as for example an optical monitoring system, a screening device, etc. The terms “central” and “decentralized” with respect to units forming a system, refer to a system, for which the arrangement of a decentralized unit relative to the central unit for the operation of the entire system in respect of a task to be performed is of no significance. To this end a data communication between the central unit and a decentralized unit preferably takes place via at least one data network, to which at least nationwide, preferably worldwide access is possible. The data communication preferably takes place by means of a terrestrial network and/or a satellite network. In particular a remote checking of the transport unit can takes place by means of the central data processing unit, where remoteness of the decentralized transport unit checking device from the central data processing unit is of no significance for performing checking function, or the performing of the checking function is not dependent on the remoteness.

In a particularly preferred embodiment it is proposed that the data communication for transfer of the data record, the processing of the data record and the provision of the same are embodied as very largely real-time processes. The organization can hereby be permanently supplied with data, which corresponds to the current checking status of the transport unit, where particularly early security measures can be initiated by the organization upon the incidence of a suspicious event. Alternatively or additionally, data acquired by the decentralized transport unit checking device is stored or archived by the central data processing unit for a later calling-up by the organization or a further organization.

A particularly reliable checking can further be achieved if the central data processing unit is provided to analyze the data record for determining a security-related event affecting the transport procedure. The central data processing unit is here expediently programmed to recognize a predefined event, on the basis of at least one data record of the decentralized transport unit checking device. This can for example be by means of a comparison of the at least one data record with stored data, such as in particular entries in a database. The occurrence of a known suspicious event, in relation to security, such as for example the breaking-open of a sealed transport unit or an inadequately or improperly performed investigation of the transport unit, can thereby be automatically and particularly rapidly detected, whereby a security measure can accordingly be initiated.

An inadequate investigation of the transport unit can be detected at an early stage, if the first interface is provided to create a data communication between the central data processing unit and the decentralized transport unit checking device, which is operated in connection with an investigation of the transport unit for the presence of non-permitted contents, which takes place in a security area protected according to security provisions preparatory to the transport procedures, and the central data processing unit is provided in at least one operating mode to process the data record in respect of a security-related event occurring during the investigation. The security area here expediently has a security zone, which is separated from its environment and for which certain physical access conditions are provided.

In this connection it is proposed that the central data processing unit processes the data record in respect of an event affecting the security area, whereby the observance of security provisions, which must be observed in connection with the investigation of the transport unit within the security area, can be checked by the organization. For example the entry and exit of persons into/out of the security area can be monitored by means of the check data processing device, via which data relating to the security area is transmitted to the organization. The registering of further events which occur during the presence of the transport unit in the security area, such as for example damage to the transport unit, failure of the video monitoring, etc. is likewise possible.

Information relating to possibly suspicious contents of the transport unit and/or an investigation which is inadequately performed, for example incompletely performed, can be transmitted rapidly and flexibly to the organization, if the central data processing unit processes the data record in respect of the contents of the transport unit.

A particularly early detection of problems in connection with an investigation of the transport unit in the security area can additionally be achieved if the central data processing unit is provided in at least one operating mode in interoperation with the decentralized transport unit checking device, in order to make the data record available for calling-up during the presence of the transport unit in the security area.

Security at the destination can likewise thereby be enhanced in that the first interface is provided to create a data communication between the central data processing unit and the decentralized transport unit checking device, which is embodied as a mobile device accompanying the transport unit during a transit of the same. The incidence of a security loophole in the period between a contents inspection at a starting location or at an intermediate station and the arrival at the destination can hereby advantageously be prevented.

In this connection early security measures can be initiated by the organization upon the incidence on suspicious events during the transit of the transport unit, if the central data processing unit in at least one operating mode in interoperation with the decentralized transport unit checking device is provided, to make the data record available to the decentralized organization during transit of the transport unit. A preferably permanent or at least regular monitoring of the transport unit in a transport means for transit of the same can hereby be effected by the organization.

### BRIEF DESCRIPTION OF THE DRAWINGS

An exemplary embodiment is described below on the basis of the drawing, in which:

FIG. 1 shows a schematic representation of a system comprising decentralized transport unit checking devices and a central check data processing device.

### DETAILED DESCRIPTION OF INVENTION

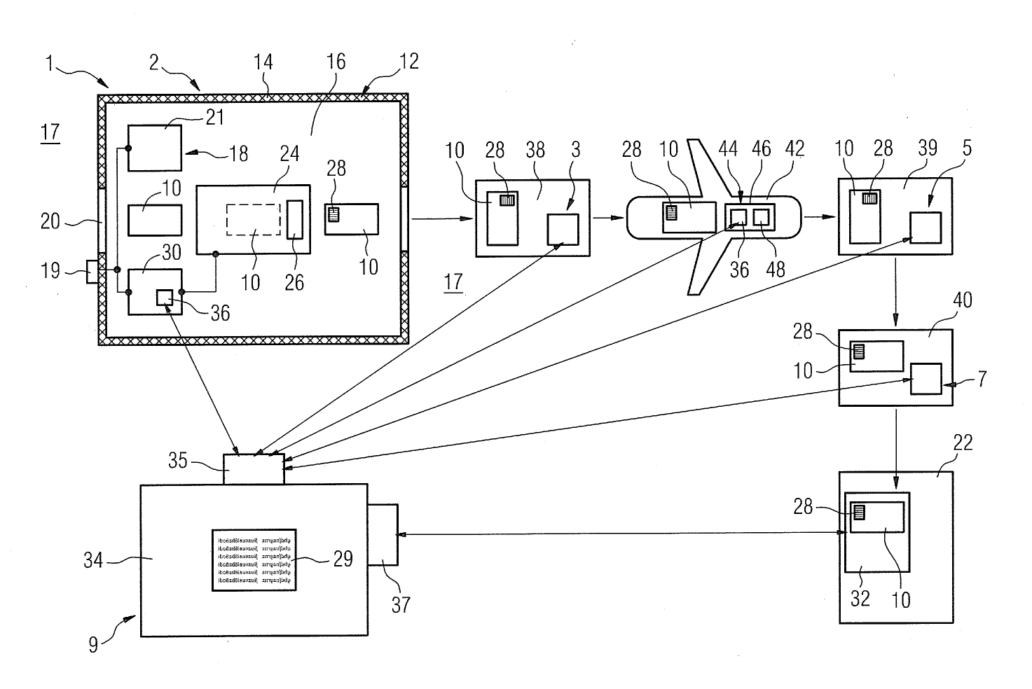

FIG. 1 shows, in a schematic view, a system comprising a set of transport unit checking devices 1, 3, 5, 7, 44 and a data processing device 9.

The transport unit checking device 1 has a checking unit 2, which is provided for local, that is to say in particular on-site checking of a transport unit 10. The checking unit 2 has a security area 12 shown from above, in which transport units 10 are subject to investigation of their contents within the handling of a transport procedure. In the present example, the transport unit 10 represented is embodied as a freight container, in particular as a standardized cargo container. The security area 12 has a surrounding fence 14, which serves to delimit a security zone 16 and to prevent unauthorized access to this security zone 16. Access to the security zone 16 or presence in the security zone 16 are subject to security provisions, which relate in particular to the authorization of personnel and the equipping of the security area 12 with control and monitoring means, whereby the security zone 16 is protected in relation to external grounds 17 or has a higher security level than the external grounds 17.

The security area 12 is monitored by a monitoring unit 18, which serves to register security-related events in connection with the security area 12. The monitoring unit 18 has an access authorization device 19, which regulates access to the security zone 16. This controls a gate 20, where only authorized persons may be present in the security zone 16.

The access authorization device 19 can for example have a reader unit, which permits access by means of an ID badge. Alternatively or additionally the access authorization device 19 has a recording unit, which serves to capture biometric characteristics, such as for example a fingerprint. The monitoring unit 18 further has a monitoring device 21 for the permanent monitoring of the security zone 16. This can for example have a video camera, an infrared sensor, a movement detector, etc.

Preparatory to a transport procedure, in which a transport unit 10 is to be transported from a starting location to a destination 22, an unchecked transport unit 10 is transferred into the security area 12. To perform the investigation the checking unit 2 has an investigation device 24 in the security zone 16, by means of which the contents of the transport unit 10 is checked in respect of illegal materials, such as for example illegal drugs, explosives, etc. and/or for characteristics which could potentially endanger safety/security during the transport and at the destination. The investigation device 24 can be provided for the manual scanning of the contents by personnel and/or by a trained animal and/or it can have means for scanning the contents by means of an investigation signal, such as for example an X-ray beam.

If the transport unit 10 is approved for the transport procedure, this is uniquely marked by means of an identification device 26 as an approved transport unit 10, where this identification represents a mandatory prerequisite for transport approval. The marking of the transport unit 10 by means of identification device 26 can take place in different ways, whereby the marking can take place manually, semi-automatically or fully-automatically. For example the transport unit 10 can be marked by means of seal 28, which is for example embodied as a lead seal. In an alternative embodiment, the marking can be through the application of a barcode to the transport unit 10 and/or through the programming of a chip affixed to the transport unit 10, such as for example an RFID. After the marking of the transport unit 10 this is transported from the security area 12 for initiation of the transport procedure or it can be made available in the security zone 16 and transported away from there at a later point in time.

The transport unit 10 is represented in the security zone 16 prior to its investigation as unchecked transport unit 10, during investigation in the investigation device 24 and as an approved transport unit 10 with the identifier, specifically the seal 28. During the presence of the transport unit 10 in the security area 12 a data record 29 is created, which is uniquely assigned to the transport unit 10. The data record 29 contains data relating to the investigated contents of the transport unit 10. Further, data is collected during the presence of the transport unit 10, which relates to the security area 12. For example data can be incorporated into the data record 29 which relates to employees' access to the security zone 16. For example any access authorizations which have taken place before the transport unit 10 has left the security area 12 can be registered.

In addition the data from the monitoring device 21 can be added to the data record 29. Events occurring in the security area 12 during the presence of the transport unit 10 can thus be registered in the data record 29. A data processing unit 30 is assigned to the security area 12, which captures data from the access authorization device 19, the monitoring device 21 and the investigation device 24, and creates the corresponding data record 29.

The data record 29 is made available to the organization 32 affected by the transport procedure at the destination location 22. A customs authority or border protection agency assigned to the destination 22 can for example hereby interrogate the data record 29 and evaluate it in respect of potentially suspicious events in relation to the investigation of the transport unit 10 in the security area 12. This takes place by means of the check data processing device 9, which is used in interoperation with the transport unit checking device 1.

The check data processing device 9 has a central data processing unit 34, which serves to process the data record 29 captured by the transport unit checking device 1 in respect of the transport procedure of the transport unit 10. Data interfaces are provided for the creation of a data communication between the central data processing unit 34 and the transport unit checking device 1. The data processing device 9 has a first interface 35, which serves to create the data communication with an interface unit 36 of the transport unit checking device 1, and in particular its data processing unit 30. This is in interoperation with the access authorization device 19, with the monitoring device 21 and with the investigation device 24, so that data from these devices can be sent to the check data processing device 9 via the interface unit 36.

The data transfer between the first interface 35 and the interface unit 36 takes place via a data network which is not represented in greater detail, which corresponds to a terrestrial and/or a satellite network. Any desired relative arrangement of the transport unit checking device 1 and the check data processing device 9 can exist, as the data network enables remote access by the central data processing unit 34 to a data record 29 of the decentralized transport unit checking device. For example these devices can be arranged in different continents.

The check data processing device 9 further has a second interface 37, which serves the creation of a data communication with the organization 32. Via this interface 37, the data record 29 processed by the central data processing unit 34 is made available for calling-up by the organization 32.

In a first embodiment, the data communication for transfer of the data record 29 between the decentralized transport unit checking device 1 and the central data processing unit 34 and the organization 32, the processing of the data record 29 and the provision of the same by the central data processing unit 34 are very largely embodied as real time processes. Accordingly, the organization 32 can check the course of the investigation processes in the security area 12 in real time and preferably permanently.

Alternatively or additionally, in a second embodiment, the central data processing unit 34 can collect data from the decentralized transport unit checking device 1, which remains available to the organization 32 for calling up at any desired point in time. During the presence of the transport unit 10 in the security area 12 and after its departure from the security area 12, for example during a transit of the transport unit 10 in a transport means, the data record 29 remains available to the organization for calling up. It is also possible for the data record 29 to continue to remain available after the transport unit 10 has reached the destination 22.

The central data processing unit 34 has different operating modes, which relate to the nature of the data received by the decentralized transport unit checking device 1.

In one operating mode the data processing unit 34 can process the data record 29 in respect of the monitoring of the security area 12. Thus suspicious events can be determined, which have occurred in connection with the security area 12, such as for example the intrusion of an unauthorized person into the security zone 16, the presence of a person in the immediate environs of the transport unit 10, damage to the transport unit 10, etc.

In a further operating mode the central data processing unit 34 processes the data record 29 in respect of the contents of the transport unit 10. For example it can process an investigation report of the investigation device 24. An inadequate investigation of the contents of the transport unit 10 can hereby be determined, such as for example an incomplete investigation or the failure to observe security provisions during the investigation.

The processing of the data record 29 can depend on the characteristics of the capture of data by the transport unit checking device 1, that is on the manner in which this data is made available, and/or on the wishes of the organization 32 as commissioning party vis-à-vis the operator of the check data processing device 9 as the service provider. The data record 29 can thus be made available by the central data processing unit 34 without processing, purely for forwarding to the organization 32, which performs an analysis autonomously, or the central data processing unit can be provided to analyze the data record 29 for the recording of a security-related event affecting the transport procedure, where an analysis result is provided for calling-up by the organization 32. For example predefined events can be determined by means of the data processing unit 34, in that an analysis of the data record 29 is performed with respect to an existing database of events, which is known to the data processing unit 34.

During the transport procedure between the location of the investigation in the security area 12 and the task assigned to the official body 32, the transport unit 10 can be temporarily stored at various intermediate stations 38, 39, 40, where the number of intermediate stations is arbitrary. During the presence of the transport unit 10 at an intermediate station, the transit of the transport unit 10 is interrupted. An intermediate station can in particular correspond to a device, in which the mode of transport of the transport unit 10 is switched. For example the intermediate station can be a transshipment railroad station, the cargo area of an airport or a harbor. The intermediate stations 38, 39, 40 are in each case equipped with a transport unit checking device 3, 5 or 7, by means of which the transport unit 10 is checked during the storage period, in particular is monitored. Data which is collected during this monitoring, is added to the data record 29 assigned to the transport unit 10 in the central data processing unit 34, so that it is likewise accessible to the official authority 32. In particular the identifier, and specifically in the present example the seal 28, is checked by the respective transport unit checking device 3, 5 or 7. If the seal 28 is damaged, this can be ascertained by the official authority 32, and special measures provided, before the transport unit 10 is handed over to the official authority 32. The transport unit checking devices 3, 5, 7 in each case have an interface unit 36, by means of which a data communication can be created with the first interface 35 of the check data processing device 9.

During its transit in a transport means 42 the transport unit 10 can further be monitored by means of a mobile transport unit checking device 44. This can, as described above, register events affecting the transport unit 10, and in particular can check the state of the seal 28, and the captured data can be added to the data record 29 in the central data processing unit 34 via an interface unit 36. To this end the first interface 35 is provided for data communication with the decentralized transport unit checking device 42, which is embodied as a mobile device accompanying the transport unit 10 during its transit. The transport unit checking device 44 has a checking unit 46 for local checking of the transport unit 10 in the transport means 42, which comprises a mobile checking means 48, which accompanies the transport unit 10 during its transit, embodied as video monitoring or monitoring of the seal status. During the transit of the transport unit 10, a data record is captures by the checking means 48 and transmitted by means of the interface unit 36, which interoperates with the checking means 48, to the central data processing unit 34 via the first interface 35. The organization 32 can thus track the checking of the transport unit 10 at any time during the transit of the same, or data can be collected during the transit by the central data processing unit 34, which can be called up by the organization at a later point in time, for example upon the arrival of the transport unit 10 at the destination 22.

1.-15. (canceled)

16. A data processing device for use with a decentralized transport unit checking device, comprising:
a central data processing unit remote from the transport unit checking device;
a first interface which creates a data communication between the central data processing unit and the decentralized transport unit checking device,
wherein the central data processing unit processes a data record captured by the decentralized transport unit checking device in respect of a transport procedure of the transport unit; and
a second interface providing the data record, which is processed by the central data processing unit, to a decentralized organization,
wherein the decentralized organization initiates a security measure depending on the data record.

17. The data processing device as claimed in claim 16, wherein a transfer of the data record, the processing of the data record and the provision of the data record are real-time processes.

18. The data processing device as claimed in claim 16, wherein the central data processing unit analyzes the data record in order to determine a security-related event which affects the transport procedure.

19. The data processing device as claimed in claim 16,
wherein the first interface creates a data communication between the central data processing unit and the decentralized transport unit checking device,
wherein the data communication is operated in connection with an investigation of the transport unit for a presence of non-permitted contents, and
wherein the investigation takes place in a security area protected according to security provisions preparatory to the transport procedures.

20. The data processing device as claimed in claim 19, wherein the central data processing unit processes the data record in respect of a security-related event occurring during the investigation.

21. The data processing device as claimed in claim 19, wherein the central data processing unit processes the data record in respect of an event affecting the security area.

22. The data processing device as claimed in claim 19, wherein the central data processing unit processes the data record in respect of contents of the transport unit.

23. The data processing device as claimed in claim 19, wherein the decentralized transport unit checking device retrieves the data record during a presence of the transport unit within the security area, wherein the central data processing unit provides the data record to the decentralized transport unit checking device.

24. The data processing device as claimed in claim 16, wherein the first interface creates a data communication between the central data processing unit and the decentralized transport unit checking device.

25. The data processing device as claimed in claim 24, wherein the decentralized transport unit checking device is a mobile device accompanying the transport unit during transit of the same.

26. The data processing device as claimed in claim 24, wherein the central data processing unit provides, in interoperation with the decentralized transport unit checking device, the data record to the decentralized organization during transit of the transport unit.

27. A system, comprising:
at least one transport unit checking device comprising
a checking unit for a local checking of a transport unit, and
a data processing device comprising a central data processing unit, a first interface and a second interface,
an interface unit which creates a data communication to the first interface of the data processing device.

28. The system as claimed in claim 27, wherein the checking unit includes
at least one investigation device for investigation of the transport unit in relation to the presence of non-permitted contents,
a security area protected according to security provisions, in which the investigation device is arranged, and
a monitoring device for monitoring of the security area,
wherein data records of the at least one investigation device and the monitoring device are transmitted to the data processing device via the interface unit.

29. The system as claimed in claim 27, wherein the checking unit includes at least one mobile checking device, accompanying the transport unit during a transit of the same, wherein a data record of the mobile checking device is transmitted to the data processing device during the transit of the transport unit.

30. A method, comprising:
providing a transport unit,
checking the transport unit locally by a decentralized transport unit checking device,
transmitting a data record to a data processing device via an interface unit of the transport unit checking device,
processing the data record of the check data processing device in respect of a transport procedure of the transport unit; and
providing the data record for calling-up by a decentralized organization, which initiates a security measure depending on data record.

31. The method as claimed in claim 30, further comprising:
checking the transport unit by an investigation device of the decentralized transport unit checking device in a security area protected according to security provisions for presence of non-permitted contents;
monitoring the security area by a monitoring device; and
transmitting data records from the investigation device and the monitoring device to the data processing device.

32. The method as claimed in claim 30, wherein the transport unit is checked by a mobile checking device which accompanies the transport unit during a transit of the same, and wherein a data record of the mobile checking device is transmitted to the data processing device.
